(19) United States
(12) Patent Application Publication
(10) Pub. No.: US 2026/0280467 A1
(43) Pub. Date: Sep. 17, 2026

(54) MOTOR DRIVE CIRCUIT, MOTOR DRIVE METHOD, AND MOTOR DRIVE SYSTEM

(71) Applicants: Kabushiki Kaisha Toshiba, Tokyo (JP); Toshiba Electronic Devices & Storage Corporation, Tokyo (JP)

(72) Inventors: Shen WANG, Yokohama Kanagawa (JP); Hiroyuki ISHIDA, Yokohama Kanagawa (JP)

(21) Appl. No.: 19/228,073

(22) Filed: Jun. 4, 2025

(30) Foreign Application Priority Data
Mar. 17, 2025 (JP) 2025-042289

(51) Int. Cl. H02P 29/024

(52) U.S. Cl. CPC H02P 29/027

(57) ABSTRACT

A motor drive circuit, according to one embodiment includes: a power source cutoff detection circuit detects that the power source has been cut off based on a detection result, and outputs a power source cutoff detection signal; a voltage detection circuit that detects the supply voltage of the power supply terminal, and outputs a voltage detection signal based on a detection result; a motor driver circuit supplies a drive current to the motor to rotate the motor, the driver circuit controlling a coil current flowing through a coil of the motor to brake the motor; an overcurrent detection circuit that detects that the coil current is equal to or greater than a preset threshold current, and outputs an overcurrent detection signal; and a control circuit that controls the operation of the motor.

### CROSS-REFERENCETORELATEDAPPLICATIONS

This application is based upon and claims the benefit of priority from the prior Japanese Patent Application No. 2025-042289, filed on Mar. 17, 2025 the entire contents of which are incorporated herein by reference.

### FIELD

The present embodiment relates to a motor drive circuit, a motor drive method, and a motor drive system.

### BACKGROUND

Conventionally, for example, there is a motor drive circuit that performs a short-brake operation on the motor in response to a request to stop the motor.

### BRIEF DESCRIPTION OF THE DRAWINGS

FIG. 1 is a diagram showing an example of the configuration of a motor drive system including a motor drive circuit according to a first embodiment.

FIG. 2 is a diagram showing an example of the relationship between the motor control operation by the motor drive circuit shown in FIG. 1 and the detected supply voltage, power interruption detection voltage, and coil current of the motor.

FIG. 3 is a diagram showing an example of the relationship between the motor control operation by the motor drive circuit shown in FIG. 1 and signal waveforms in the motor drive circuit.

FIG. 4 is a diagram showing an example of the relationship between the motor control operation by a motor drive circuit according to a modified example and the detected supply voltage, power interruption detection voltage, and coil current of the motor.

FIG. 5 is a diagram showing an example of the relationship between the motor control operation by the motor drive circuit according to a modified example and signal waveforms in the motor drive circuit.

### DETALED DESCRIPTION

One embodiment aims to provide a motor drive circuit that can stop the motor more quickly after the power source to the motor is cut off (for example, the power source may be disconnected from the power source terminal, or the power source voltage of the power source may drop, resulting in a state where the desired power cannot be supplied) while the motor is being driven, suppress overcurrent during short braking of the motor, and avoid unstable operation due to induced voltage of the motor.

A motor drive circuit, according to one embodiment, that controls driving of a motor using power input from a power source through a power supply terminal, includes:

a power source cutoff detection circuit that detects a voltage input through a power source cutoff detection terminal electrically connected to a power source terminal, detects that the power source has been cut off based on a detection result, and outputs a power source cutoff detection signal;

a voltage detection circuit that detects the supply voltage of the power supply terminal, and outputs a voltage detection signal based on a detection result;

a driver circuit that includes a first half bridge, a second half bridge, and a third half bridge connected in parallel between the power supply terminal and a ground terminal, the motor driver circuit supplying a drive current to the motor to rotate the motor, the driver circuit controlling a coil current flowing through a coil of the motor to brake the motor;

an overcurrent detection circuit that detects the coil current flowing through the coil of the motor through the driver circuit during a short-brake operation of the motor, detects that the coil current is equal to or greater than a preset threshold current, and outputs an overcurrent detection signal; and

a control circuit that controls the operation of the motor by controlling the driver circuit based on the power source cutoff detection signal, the overcurrent detection signal, and the voltage detection signal.

The motor drive circuit according to the embodiment will be described in detail below with reference to the attached drawings. It is noted that the present invention is not limited to these embodiments.

### First embodiment

### Motor drive system

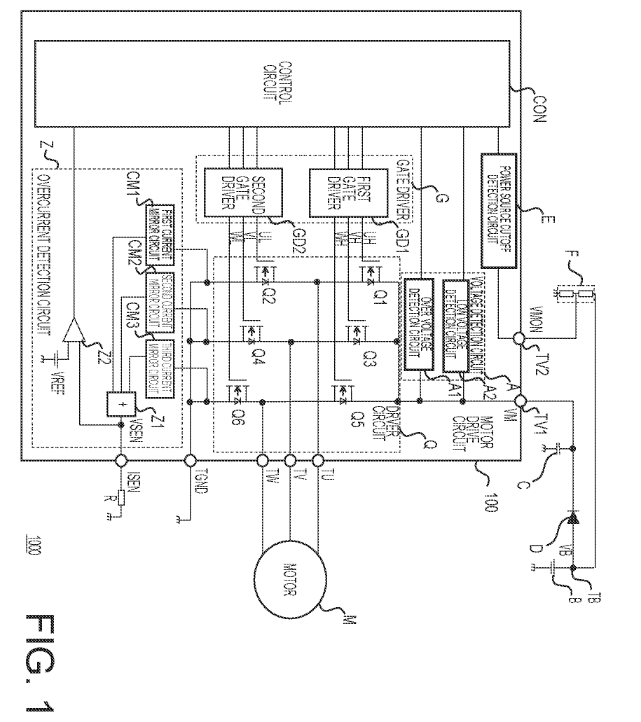

FIG. 1 shows an example of the configuration of a motor drive system including a motor drive circuit according to the first embodiment.

The motor drive system 1000 that controls the driving of the motor M includes, for example, a power source B, a power source terminal TB, a diode D, a smoothing capacitor C, a voltage scaling circuit F, and a motor drive circuit 100, as shown in FIG. 1.

### Motor

Motor M is a three-phase motor including U-phase, V-phase, and W-phase coils (not shown). The U-phase, V-phase, and W-phase coils of motor M are connected to the first motor terminal TU, the second motor terminal TV, and the third motor terminal TW, respectively.

### Power source terminal

Furthermore, the power source terminal TB is adapted to have a power source B connected between it and the ground, as shown in FIG. 1, for example. In other words, when the power source B is connected between the power source terminal TB and the ground, the power source B outputs a power source voltage VB.

### Diode

As shown in FIG. 1, the anode of diode D is connected to the power source terminal TB, and the cathode of diode D is connected to the power supply terminal TV1.

### Smoothing capacitor

One end of the smoothing capacitor C is connected to the cathode of diode D, and the other end of the smoothing capacitor C is connected to ground. This smoothing capacitor C is designed to smooth the voltage at the power supply terminal TV1.

### Voltage scaling circuit

The voltage scaling circuit F also adjusts the voltage at the power source terminal TB and outputs the scaled voltage (power interruption detection voltage) to the power interruption detection terminal TV2. In this embodiment, the voltage scaling circuit F may be a voltage divider circuit.

For example, when power source B is not cut off, the voltage scaling circuit F outputs a voltage obtained by adjusting the power source voltage VB to the power source cutoff detection terminal TV2.

On the other hand, when power source B is cut off because power source B is disconnected from power source terminal TB, for example, the voltage scaling circuit F outputs the ground voltage to power source cutoff detection terminal TV2.

In other words, the detection voltage VMON at the power source cutoff detection terminal TV2 is a voltage obtained by adjusting the power source voltage VB when power source B is not cut off. On the other hand, when power source B is cut off, the detection voltage VMON is the ground voltage.

In this way, the power source interruption detection circuit E can check whether the power source B is interrupted by detecting the detection voltage VMON at the power source interruption detection terminal TV2.

### Motor drive circuit

Motor drive circuit 100 also controls the drive of motor M using power input from power source B via power supply terminal TV1 to which one end of smoothing capacitor C is connected.

The motor drive circuit 100 according to this embodiment includes, for example, a power source cutoff detection circuit E, a voltage detection circuit A, a gate driver G, a driver circuit Q, an overcurrent detection circuit Z, and a control circuit CON, as shown in FIG. 1.

It is noted that each circuit configuration of the motor drive system 1000, including the motor drive circuit 100 shown in FIG. 1, is an example, and the system may be configured with other circuit configurations that can perform similar functions.

These configurations of the motor drive circuit 100 in this embodiment are described in detail below.

### Power source cutoff detection circuit

For example, as shown in FIG. 1, the power source cutoff detection circuit E detects the voltage input via the power source cutoff detection terminal TV2 electrically connected to the power source terminal TB via a voltage scaling circuit F, and outputs a power source cutoff detection signal when the power source cutoff detection circuit E detects that the power source B has been cut off (e.g., the power source B is disconnected from the power source terminal TB, or the power source voltage VB of the power source B drops and the desired power is not supplied.) based on the detection result. In this way, in the embodiment and the modified example described below, not only the state in which the power source B is disconnected from the power source terminal TB, but also the state in which the power source voltage VB of the power source B drops and the desired power is not supplied to the motor drive circuit 100 is defined as the detection target of the power source cutoff detection circuit E as the power source B being cut off.

### Voltage detection circuit

The voltage detection circuit A detects the supply voltage VM of the power supply terminal TV1 and outputs a voltage detection signal based on the detection result.

This voltage detection circuit A includes, for example, an overvoltage detection circuit A1 and a low voltage detection circuit A2, as shown in FIG. 1.

The overvoltage detection circuit A1 detects the supply voltage VM, detects whether the supply voltage VM is higher than a preset first threshold voltage (overvoltage threshold) VTH1, and outputs a signal according to the detection result to the control circuit CON as a voltage detection signal.

Furthermore, the low voltage detection circuit A2 detects the supply voltage VM to detect whether the supply voltage VM is lower than a preset second threshold voltage (detection threshold) VTH2 that is lower than the first threshold voltage VTH1, and outputs a signal according to this detection result to the control circuit CON as a voltage detection signal.

It is noted that the first threshold voltage VTH1 is set, for example, to be lower than the voltage (for example, power source voltage VB) at the power supply terminal TV1 when power source B is not cut off. However, the first threshold voltage VTH1 may be set to be higher than the voltage at the power supply terminal TV1 when power source B is not cut off.

It is noted that the second threshold voltage VTH2 is, for example, a voltage at which the control circuit CON can operate stably.

### Driver circuit

The driver circuit Q uses the power supplied from the power source B to supply a drive current to the motor M to rotate the motor. On the other hand, the driver circuit Q controls the current flowing through the coil of the motor M to apply the brakes.

The driver circuit Q includes, for example, a first half-bridge (Q1, Q2), a second half-bridge (Q3, Q4), and a third half-bridge (Q5, Q6) connected in parallel between the power supply terminal TV1 and a ground terminal TGND connected to ground, as shown in FIG. 1.

Furthermore, the first motor terminal TU is connected to one end of a U-phase coil (not shown) of motor M, which is a three-phase motor, as shown in FIG. 1, for example.

Furthermore, the second motor terminal TV is connected to one end of a V-phase coil (not shown) of motor M, as shown in FIG. 1, for example.

Furthermore, the third motor terminal TW is connected to one end of a third coil (not shown) of motor M, as shown in FIG. 1, for example.

The other end of the U-phase coil, the other end of the V-phase coil, and the other end of the W-phase coil are connected to the center terminal (not shown) of motor M.

The first half bridge (Q1, Q2) is configured by connecting a first high-side MOS transistor Q1 and a first low-side MOS transistor Q2 in series between the power supply terminal TV1 and the ground terminal TGND.

The connection point between the first high-side MOS transistor Q1 and the first low-side MOS transistor Q2 of this first half bridge is connected to the first motor terminal TU.

The first high-side MOS transistor Q1 has one end (drain) connected to the power supply terminal TV1 and the other end (source) connected to the first motor terminal TU.

Furthermore, the first low-side MOS transistor Q2 has one end (drain) connected to the first motor terminal TU and the other end (source) connected to the ground terminal TGND.

The second half bridge (Q3, Q4) is configured by connecting a second high-side MOS transistor Q3 and a second low-side MOS transistor Q4 in series between the power supply terminal TV1 and the ground terminal TGND.

The connection point between the second high-side MOS transistor Q3 and the second low-side MOS transistor Q4 of this second half bridge (Q3, Q4) is connected to the second motor terminal TV.

The second high-side MOS transistor Q3 has one end (drain) connected to the power supply terminal TV1 and the other end (source) connected to the second motor terminal TV.

The second low-side MOS transistor Q4 has one end (drain) connected to the second motor terminal TV and the other end (source) connected to the ground terminal T.

The third half bridge (Q5, Q6) is configured by connecting a third high-side MOS transistor Q5 and a third low-side MOS transistor Q6 in series between the power supply terminal TV1 and the ground terminal TGND.

The connection point between the third high-side MOS transistor Q5 and the third low-side MOS transistor Q6 of this third half bridge (Q5, Q6) is connected to the third motor terminal TW.

The third high-side MOS transistor Q5 has one end (drain) connected to the power supply terminal TV1 and the other end (source) connected to the third motor terminal MT3.

The third low-side MOS transistor Q6 has one end (drain) connected to the third motor terminal TW and the other end (source) connected to the ground terminal TGND.

The first to third half bridges (Q1, Q2), (Q3, Q4), (Q5, Q6) are connected in parallel between the power supply terminal TV1 and the ground terminal TGND, for example, as shown in FIG. 1.

### Gate driver

The gate driver G also outputs gate control signals UH, UL, VH, VL, WH, and WL to the gates of the MOS transistors Q1, Q2, Q3, Q4, Q5, and Q6 of the driver circuit Q in response to the signal output from the control circuit CON, thereby controlling the operation of the MOS transistors Q1, Q2, Q3, Q4, Q5, and Q6.

In other words, the operation of this gate driver G allows the control circuit CON to cause the driver circuit Q to perform the desired control.

As shown in FIG. 1, the gate driver G includes a first gate driver G1 that outputs gate control signals UH, VH, and WH, and a second gate driver G2 that outputs gate control signals UL, VL, and WL.

### Overcurrent detection circuit

The overcurrent detection circuit Z detects the coil current IL flowing through the coil of motor M via the driver circuit Q during short-brake operation of motor M, and outputs an overcurrent detection signal if the overcurrent detection circuit Z detects that the coil current IL is an overcurrent equal to or greater than a preset threshold current (overcurrent threshold) IOCL.

As shown in FIG. 1, the overcurrent detection circuit Z includes a first current mirror circuit CM1, a second current mirror circuit CM2, a third current mirror circuit CM3, a summing circuit Z1, and a comparator Z2. This summing circuit Z1 is sometimes called an adder circuit.

The first current mirror circuit CM1 is configured to output a first current obtained by current-mirroring the current flowing through the first low-side MOS transistor Q2.

The second current mirror circuit CM2 is configured to output a second current obtained by current-mirroring the current flowing through the second low-side MOS transistor Q4.

The third current mirror circuit CM3 is configured to output a first current obtained by current-mirroring the current flowing through the third low-side MOS transistor Q6.

The summing circuit Z1 receives the first current, the second current, and the third current, and adds or outputs the first current, the second current, and the third current, respectively.

In addition, during short-brake operation of motor M, the comparator Z2 compares a comparison voltage based on the detected current output by summing circuit Z1 with a preset reference voltage VREF, and the comparator Z2 outputs an overcurrent detection signal if the comparison voltage is equal to or higher than reference voltage VREF, and the comparator Z2 does not output an overcurrent detection signal if the comparison voltage is less than reference voltage VREF.

The comparison voltage is a voltage generated when a detection current ISEN flows through a resistor R external to the motor drive circuit 100.

In this way, during the short-brake operation of motor M, the overcurrent detection circuit Z indirectly detects the coil current flowing through the coil of motor M via the driver circuit Q based on the first current, second current, and third current (i.e., based on the detected current ISEN), and when the overcurrent detection circuit Z detects that the coil current is an overcurrent equal to or greater than the threshold current IOCL, the overcurrent detection circuit Z outputs an overcurrent detection signal.

### Control circuit

The control circuit CON controls the operation of the motor M by controlling the driver circuit Q via the gate driver G based on the power source cutoff detection signal output by the power source cutoff detection circuit E, the overcurrent detection signal output by the overcurrent detection circuit Z, and the voltage detection signal output by the voltage detection circuit A.

The control circuit CON is adapted to operate when supplied with the supply voltage VM.

Here, for example, when the control circuit CON drives motor M in the normal mode, the control circuit CON outputs gate signals UH, VH, WH, UL, VL, and WL to the driver circuit Q via the gate driver G, and PWM controls the first to third half bridges (Q1, Q2), (Q3, Q4), and (Q5, Q6) to drive motor M.

Furthermore, when the control circuit CON short-brakes motor M, the control circuit CON outputs gate signals UH, VH, WH, UL, VL, and WL from the gate driver G to the driver circuit Q to turn off the first, second, and third high-side MOS transistors Q1, Q3, and Q5 of the first through third half-bridges (Q1, Q2), (Q3, Q4), and (Q5, Q6) and turn on the first, second, and third low-side MOS transistors Q2, Q4, and Q6 of the first through third half-bridges (Q1, Q2), (Q3, Q4), and (Q5, Q6) so as to short-brake motor M.

In this case, the first, second, and third motor terminals TU, TV, and TW of motor M are shorted, causing current to flow through the U-phase, V-phase, and W-phase coils of motor M and the first, second, and third low-side MOS transistors Q2, Q4, and Q6, converting the rotational energy of motor M into thermal energy. As a result, a brake (a so-called short brake) is applied to motor M.

During this short brake, the current flowing through the first, second, and third low-side MOS transistors Q2, Q4, and Q6 can be detected via the first, second, and third current mirror circuits CM1, CM2, and CM3 of the overcurrent detection circuit Z.

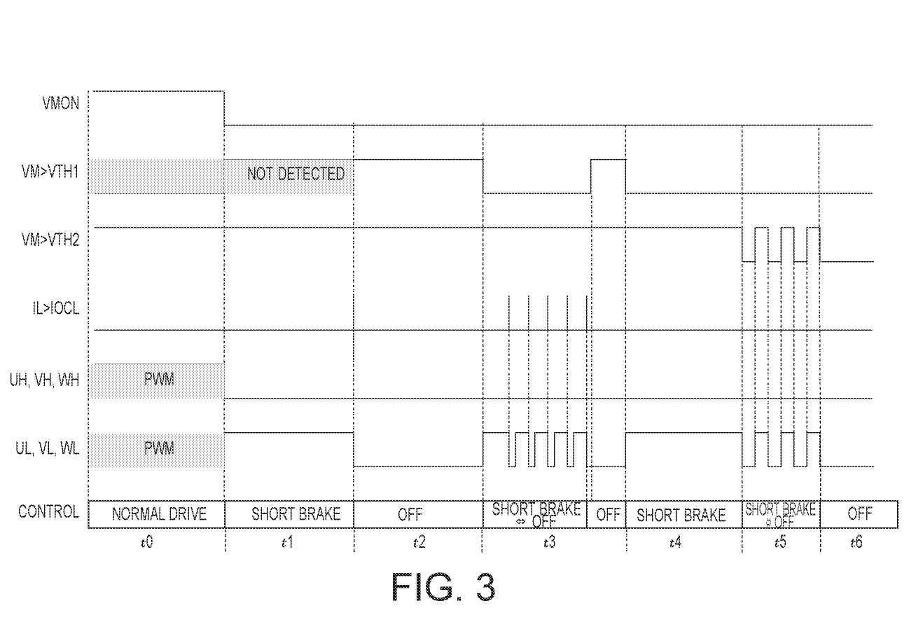

When the control circuit CON turns off and brakes the motor M, as shown in FIG. 3, the control circuit CON causes the gate driver G to output gate signals UH, VH, WH, UL, VL, and WL to the driver circuit Q so as to turn off and brake the motor M, to turn off the first, second, and third high-side MOS transistors Q1, Q3, and Q5 of the first to third half-bridges (Q1, Q2), (Q3, Q4), and (Q5, Q6), and to turn off the first, second, and third low-side MOS transistors Q2, Q4, and Q6.

In this case, when all MOS transistors Q1 to Q6 are turned off, the induced voltage of the rotating motor M causes a current to flow through the parasitic diodes of each MOS transistor Q1 to Q6, and the smoothing capacitor C is charged via the power supply terminal TV1. Then, the rotation speed of motor M will decrease due to the load connected to motor M and friction of motor M.

### Operation of the motor drive circuit

Next, an example of the operation of the motor drive circuit 100 having the above configuration will be described.

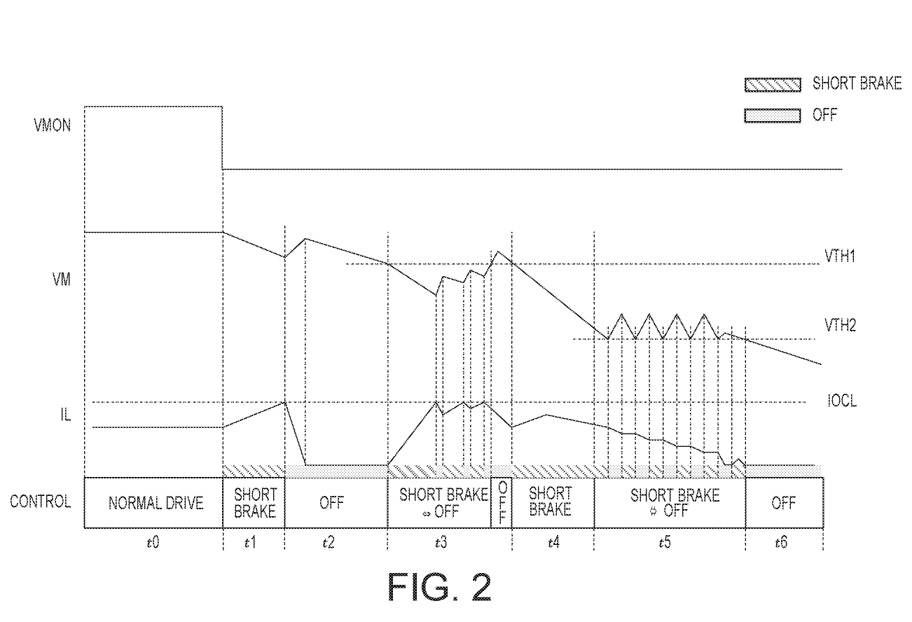

FIG. 2 is a diagram showing an example of the relationship between the motor control operation by the motor drive circuit shown in FIG. 1 and the detected supply voltage, power interruption detection voltage, and coil current of the motor. FIG. 3 is a diagram showing an example of the relationship between the motor control operation by the motor drive circuit shown in FIG. 1 and signal waveforms in the motor drive circuit.

For example, as shown in FIG. 2 and FIG. 3, during period t0, the control circuit CON drives motor M normally and rotates motor M by PWM-controlling all MOS transistors in the first to third half bridges of the driver circuit Q using gate signals UH, VH, WH, UL, VL, and WL.

Then, when the control circuit CON detects that the power source B is cut off based on the power source cutoff detection signal VMON (when the voltage value of the power source cutoff detection signal VMON drops from the scaled voltage of the power source voltage VB to the ground voltage) while the motor M is rotating by driving the motor M normally, the control circuit CON controls the high-side MOS transistors of the first to third half bridges of the driver circuit Q to be off and the low-side MOS transistors of the first to third half bridges of the driver circuit Q to be on in response to the power source cutoff detection signal VMON, thereby performing a short-brake operation on the motor M (the first period t1 in FIGS. 2 and 3).

Thereafter, if the control circuit CON detects that an overcurrent is flowing through the coil of motor M due to the short-brake operation based on the overcurrent detection signal during the short-brake operation, the control circuit CON controls all MOS transistors in the first to third half bridges of the driver circuit Q to turn off and perform the off-brake operation on motor M (the second period t2). It is noted that the control circuit CON may perform the short-brake operation on motor M after performing this off-brake operation on motor M.

Then, when the voltage detection signal indicates that the voltage detection signal is less than the first threshold voltage (overvoltage threshold) VTH1 during the off-brake operation, the control circuit CON controls the driver circuit Q to perform a short-brake operation on motor M. Then, when this short-brake operation causes an induced current in the coil of motor M to flow through the low-side MOS transistors Q2, Q4, and Q6 of the first to third half bridges, if the control circuit CON detects that an overcurrent equal to or greater than the threshold current IOCL is flowing through the low-side MOS transistors Q2, Q4, and Q6, based on the overcurrent detection signal during this short-brake operation, the control circuit CON controls the driver circuit Q to perform an off-brake operation on motor M for a preset period. Then, the control circuit CON repeats performing this short-brake operation and performing the off-brake operation (the third period t3).

In particular, when the control circuit CON operates the motor M in the off-brake mode for a preset period, if the voltage detection signal indicates that the voltage is equal to or higher than the first threshold voltage (overvoltage threshold) VTH1, the control circuit CON controls the driver circuit Q to continue the off-brake mode of the motor M.

For example, in the third period t3 in FIG. 3, the off-brake operation causes the coil current flowing through the low-side MOS transistors Q2, Q4, and Q6 to become less than the threshold current IOCL, and the smoothing capacitor C is charged via the parasitic diodes of the high-side MOS transistors Q1, Q3, and Q5 of the first to third half bridges and the power supply terminal TV1, causing the supply voltage VM to rise.

At this time, if the control circuit CON detects based on the voltage detection signal that the supply voltage VM has risen to or above the first threshold voltage VTH1, the control circuit CON continues the off-brake operation of motor M until the rotation speed of motor M decreases and the supply voltage VM falls below the first threshold voltage VTH1.

Then, the control circuit CON continues the off-brake operation of motor M until the rotation speed of motor M decreases so that the supply voltage VM becomes less than the first threshold voltage VTH1, and then controls the driver circuit Q to continue the short-brake operation of motor M (the fourth period t4).

Then, when the supply voltage VM becomes the second threshold voltage VTH2, which is lower than the first threshold voltage VTH1, the control circuit CON controls the driver circuit Q to perform the off-brake operation of motor M for a preset period of time. The induced current of motor M generated by this off-brake operation charges the smoothing capacitor C via the parasitic diodes of the high-side MOS transistors Q1, Q3, and Q5 of the first to third half bridges and the power supply terminal TV1, and the supply voltage VM rises. Then, the control circuit CON controls the driver circuit Q so that the supply voltage VM decreases, and continues the short-brake operation of motor M until the supply voltage VM becomes the second threshold voltage VTH2. Then, the control circuit CON repeats performing this short-brake operation and performing the off-brake operation (the fifth period t5). The time of the off-brake operation in the fifth period t5 may be, for example, a preset fixed time similar to that in the third period t3, or may be variably set so as to be different from that in the third period t3.

After that, even if the control circuit CON controls the driver circuit Q to perform the short-brake operation of motor M, if the rotation speed of motor M decreases and the supply voltage VM becomes less than the second threshold voltage VTH2, the control circuit CON continues the off-brake operation of motor M (the sixth period t6).

According to the above-described control operation of the motor drive circuit 100, a short-brake operation of the motor M for stopping the motor more quickly and an off-brake operation for suppressing overcurrent caused by the induced voltage of the motor are switched and executed, after the power source of the motor is cut off when the motor is driven, as a result, the supply voltage VM can be controlled within a predetermined range (the range defined by the first and second threshold voltages VTH1 and VTH2) so as to stably drive the control circuit CON of the motor drive circuit 100, after the power source is cut off.

In other words, the motor drive circuit 100 according to the first embodiment can stop the motor more quickly, suppress overcurrent during short braking of the motor, and avoid unstable operation due to induced voltage of the motor, after the power source of the motor is cut off while the motor is being driven.

### Modification

Here, in the first embodiment described above, an example of the configuration and operation of the motor drive circuit 100 has been explained. However, the configuration and operation of the motor drive circuit 100 are not limited to this. Therefore, in this modification, other examples of the configuration and operation of the motor drive circuit 100 will be explained.

As already mentioned, the low voltage detection circuit A2 of the motor drive circuit 100 shown in FIG. 1 detects the supply voltage VM, detects whether the supply voltage VM is lower than a predetermined second threshold voltage (detection threshold) VTH2 which is lower than the first threshold voltage VTH1, and outputs a signal according to this detection result to the control circuit CON as a voltage detection signal.

Furthermore, in this modified example, the low voltage detection circuit A2 of the motor drive circuit 100 may further detect the supply voltage VM, detect whether the supply voltage VM is higher than a preset third threshold voltage (the release threshold) VTH3 that is lower than the first threshold voltage VTH1 and higher than the second threshold voltage VTH2, and output a signal according to this detection result to the control circuit CON as a voltage detection signal.

Thus, in this modified example, the low voltage detection circuit A2 may have hysteresis for two thresholds, detection and release.

The configuration and operation of the motor drive circuit 100 in this modified example are the same as those in the first embodiment described above.

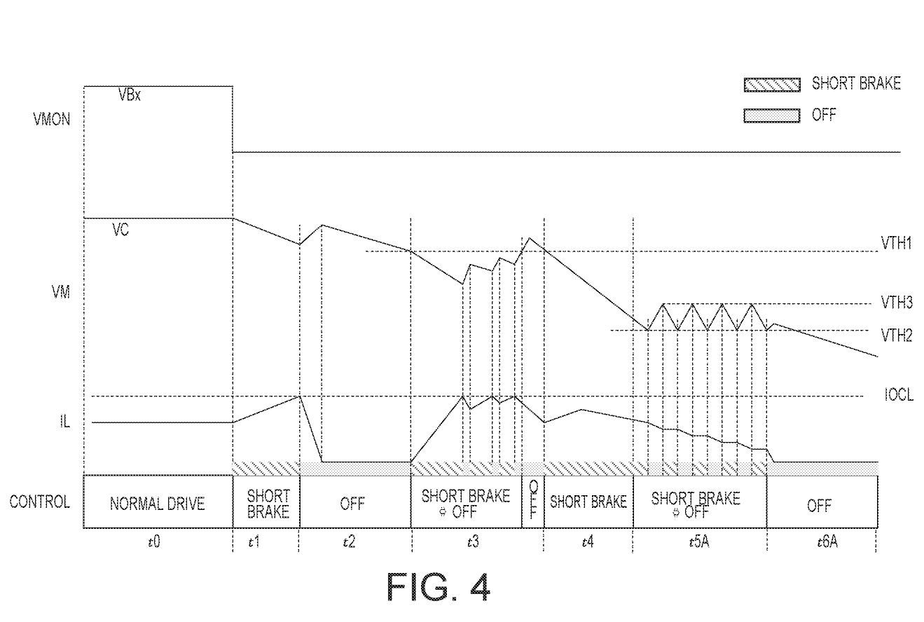

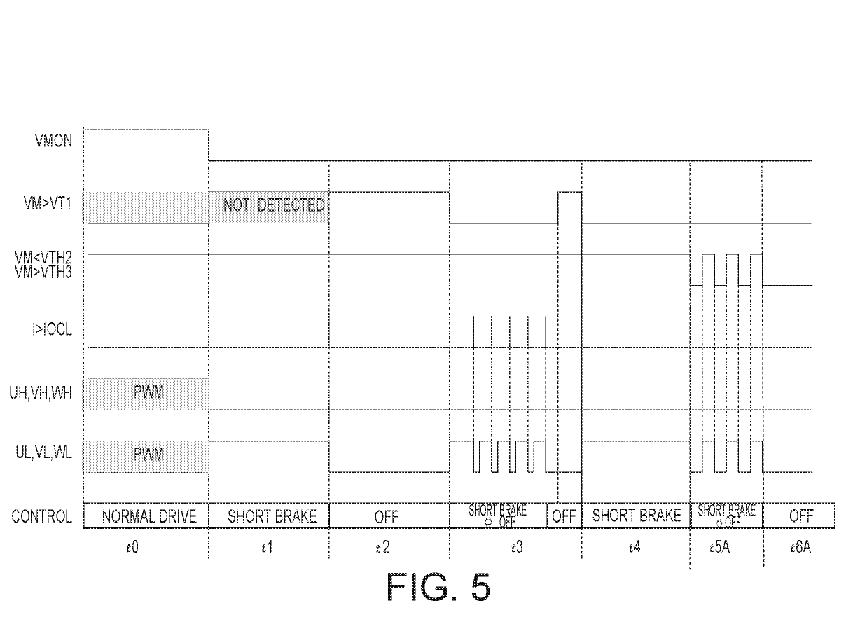

FIG. 4 is a diagram showing an example of the relationship between the motor control operation by a motor drive circuit according to a modified example and the detected supply voltage, power interruption detection voltage, and coil current of the motor. FIG. 5 is a diagram showing an example of the relationship between the motor control operation by the motor drive circuit according to a modified example and signal waveforms in the motor drive circuit.

The motor control operation from the period t0 to the fourth period t4 by the motor drive circuit according to the modified example shown in FIGS. 4 and 5 is similar to the motor control operation from the period t0 to the fourth period t4 by the motor drive circuit shown in FIGS. 2 and 3.

That is, for example, similar to the first embodiment, the control circuit CON executes the control operation from the period t0 to the fourth period t4 shown in FIGS. 4 and 5. It is noted that the time of the off-brake operation in the third period t3 may be, for example, a preset fixed time, or may be set to be variable.

Then, when the supply voltage VM becomes the preset second threshold voltage VTH2 lower than the first threshold voltage VTH1, the control circuit CON controls the driver circuit Q to perform the off-brake operation of motor M until the supply voltage VM becomes the preset third threshold voltage VTH3 lower than the first threshold voltage and higher than the second threshold voltage VTH2. The induced current of motor M generated by this off-brake operation charges the smoothing capacitor C via the parasitic diodes of the high-side MOS transistors Q1, Q3, and Q5 of the first to third half bridges and the power supply terminal TV1, and the supply voltage VM rises. Then, the control circuit CON controls the driver circuit Q so that the supply voltage VM decreases, and continues the short-brake operation of motor M until the supply voltage VM becomes the second threshold voltage VTH2. Then, the control circuit CON repeats performing this short-brake operation and performing the off-brake operation (the fifth period t5A).

After that, the control circuit CON controls the driver circuit Q to perform the short-brake operation of motor M, but if the rotation speed of motor M decreases so that the supply voltage VM becomes less than the second threshold voltage VTH2, the control circuit CON continues the off-brake operation of motor M (the sixth period t6A).

The control operation of the motor drive circuit 100 according to the modified example described above switches between the short-brake operation of the motor M to stop the motor more quickly and the off-brake operation to suppress overcurrent caused by the induced voltage of the motor, after the power source of the motor is cut off while the motor is being driven. As a result, after the power source is cut off, the supply voltage VM can be controlled within a predetermined range (a range defined by the first, second, and third threshold voltages VTH1, VTH2, and VTH3) so that the control circuit CON of the motor drive circuit 100 can be driven stably.

In other words, according to the motor drive circuit of this modification, as in the first embodiment, after the power source of the motor is cut off while the motor is being driven, the motor can be stopped more quickly, while suppressing overcurrent during short braking of the motor and avoiding unstable operation due to induced voltage of the motor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A motor drive circuit that controls driving of a motor using power input from a power source through a power supply terminal, comprising:
a power source cutoff detection circuit that detects a voltage input through a power source cutoff detection terminal electrically connected to a power source terminal, detects that the power source has been cut off based on a detection result, and outputs a power source cutoff detection signal;
a voltage detection circuit that detects the supply voltage of the power supply terminal, and outputs a voltage detection signal based on a detection result;
a driver circuit that includes a first half bridge, a second half bridge, and a third half bridge connected in parallel between the power supply terminal and a ground terminal, the motor driver circuit supplying a drive current to the motor to rotate the motor, the driver circuit controlling a coil current flowing through a coil of the motor to brake the motor;
an overcurrent detection circuit that detects the coil current flowing through the coil of the motor through the driver circuit during a short-brake operation of the motor, detects that the coil current is equal to or greater than a preset threshold current, and outputs an overcurrent detection signal; and
a control circuit that controls the operation of the motor by controlling the driver circuit based on the power source cutoff detection signal, the overcurrent detection signal, and the voltage detection signal.

2. The motor drive circuit according to claim 1, wherein
the control circuit, in a state in which the motor is rotating by driving the motor normally, controls the driver circuit in response to the power source cutoff detection signal to perform a short-brake operation on the motor,
and then, during the short-brake operation, the control circuit controls all MOS transistors of the first to third half bridges of the driver circuit to be turned off in response to the overcurrent detection signal to perform an off-brake operation on the motor,
and then, when the voltage detection signal indicates that the voltage is less than a first threshold voltage, the control circuit repeats: performing a short-brake operation on the motor by controlling the driver circuit, and performing an off-brake operation on the motor by controlling the driver circuit, in response to the overcurrent detection signal, when the short-brake operation is performed.

3. The motor drive circuit according to claim 2,
wherein, when the voltage detection signal indicates that the voltage is less than a first threshold voltage, the control circuit repeats: performing a short-brake operation on the motor by controlling the driver circuit, and performing an off-brake operation on the motor for a preset period by controlling the driver circuit, in response to the overcurrent detection signal, when the short-brake operation is performed.

4. The motor drive circuit according to claim 2, wherein the control circuit controls the driver circuit to continue the off-brake operation of the motor when the voltage detection signal indicates that the voltage detection signal is equal to or higher than the first threshold voltage when the motor is in the off-brake operation for the preset period.

5. The motor drive circuit according to claim 3, wherein the control circuit controls the driver circuit to continue the off-brake operation of the motor when the voltage detection signal indicates that the voltage detection signal is equal to or higher than the first threshold voltage when the motor is in the off-brake operation for the preset period.

6. The motor drive circuit according to claim 4, wherein
the control circuit continues an off-brake operation of the motor until the supply voltage becomes less than the first threshold voltage due to a decrease in the rotation speed of the motor,
and then controls the driver circuit to continue a short-brake operation of the motor,
and then, when the supply voltage becomes a preset second threshold voltage lower than the first threshold voltage, the control circuit repeats: performing a short-brake operation on the motor by controlling the driver circuit, and performing an off-brake operation on the motor by controlling the driver circuit in response to the overcurrent detection signal until the supply voltage becomes the second threshold voltage,
and then, when the supply voltage becomes less than the second threshold voltage, the control circuit controls the driver circuit to continue an off-brake operation of the motor.

7. The motor drive circuit according to claim 4, wherein
the control circuit continues an off-brake operation of the motor until the supply voltage becomes less than the first threshold voltage due to a decrease in the rotation speed of the motor,
and then controls the driver circuit to continue a short-brake operation of the motor, and then, when the supply voltage becomes a preset second threshold voltage lower than the first threshold voltage, the control circuit repeats: performing a short-brake operation on the motor by controlling the driver circuit, and performing an off-brake operation on the motor by controlling the driver circuit in response to the overcurrent detection signal until the supply voltage becomes the preset third threshold voltage lower than the first threshold voltage
and higher than the second threshold voltage, and then, when the supply voltage becomes less than the second threshold voltage, the control circuit controls the driver circuit to continue an off-brake operation of the motor.

8. The motor drive circuit according to claim 1, wherein the voltage detection circuit comprises:
an overvoltage detection circuit that detects whether the supply voltage is higher than a preset first threshold voltage, and outputs a signal according to a detection result as the voltage detection signal to the control circuit; and
a low voltage detection circuit that detects whether the supply voltage is lower than a preset second threshold voltage that is lower than the first threshold voltage, and outputs a signal according to a detection result as the voltage detection signal to the control circuit.

9. The motor drive circuit according to claim 8,
wherein the voltage detection circuit detects whether the supply voltage is higher than a preset third threshold voltage that is lower than the first threshold voltage and higher than the second threshold voltage, and outputs a signal according to a detection result to the control circuit as the voltage detection signal.

10. A motor drive system that controls a driving of a motor, comprising:
a power source terminal to which a power source is connected between the power source terminal and a ground;
a diode that has an anode connected to the power source terminal and a cathode connected to a power supply terminal;
a smoothing capacitor that has one end connected to the cathode of the diode and the other end connected to the ground;
a voltage scaling circuit that adjusts a voltage of the power source terminal and outputs a scaled voltage to a power source cutoff detection terminal; and
a motor drive circuit that controls driving of the motor using power input from the power source via the power supply terminal to which the one end of the smoothing capacitor is connected, wherein the motor drive circuit comprises:
a power source cutoff detection circuit that detects a voltage input through a power source cutoff detection terminal electrically connected to a power source terminal, detects that the power source has been cut off based on a detection result, and outputs a power source cutoff detection signal;
a voltage detection circuit that detects the supply voltage of the power supply terminal, and
outputs a voltage detection signal based on a detection result;
a driver circuit that includes a first half bridge, a second half bridge, and a third half bridge connected in parallel between the power supply terminal and a ground terminal, the motor driver circuit supplying a drive current to the motor to rotate the motor, while the driver circuit controlling a coil current flowing through a coil of the motor to brake the motor;
an overcurrent detection circuit that detects the coil current flowing through the coil of the motor through the driver circuit during a short-brake operation of the motor, detects that the coil current is equal to or greater than a preset threshold current, and outputs an overcurrent detection signal; and
a control circuit that controls the operation of the motor by controlling the driver circuit based on the power source cutoff detection signal, the overcurrent detection signal, and the voltage detection signal.

11. The motor drive system according to claim 10, wherein the control circuit, in a state in which the motor is rotating by driving the motor normally, controls the driver circuit in response to the power source cutoff detection signal to perform a short-brake operation on the motor,
and then, during the short-brake operation, the control circuit controls all MOS transistors of the first to third half bridges of the driver circuit to be turned off in response to the overcurrent detection signal to perform an off-brake operation on the motor,
and then, when the voltage detection signal indicates that the voltage is less than a first threshold voltage, the control circuit repeats: performing a short-brake operation on the motor by controlling the driver circuit, and performing an off-brake operation on the motor by controlling the driver circuit, in response to the overcurrent detection signal, when the short-brake operation is performed.

12. The motor drive system according to claim 11, wherein, when the voltage detection signal indicates that the voltage is less than a first threshold voltage, the control circuit repeats: performing a short brake-operation on the motor by controlling the driver circuit, and performing an off-brake operation on the motor for a preset period by controlling the driver circuit, in response to the overcurrent detection signal, when the short-brake operation is performed.

13. The motor drive system according to claim 11, wherein the control circuit controls the driver circuit to continue the off-brake operation of the motor when the voltage detection signal indicates that the voltage detection signal is equal to or higher than the first threshold voltage when the motor is in the off-brake operation for the preset period.

14. The motor drive system according to claim 12, wherein the control circuit controls the driver circuit to continue the off-brake operation of the motor when the voltage detection signal indicates that the voltage detection signal is equal to or higher than the first threshold voltage when the motor is in the off-brake operation for the preset period.

15. The motor drive system according to claim 13, wherein the control circuit continues an off-brake operation of the motor until the supply voltage becomes less than the first threshold voltage due to a decrease in the rotation speed of the motor, and then controls the driver circuit to continue a short-brake operation of the motor,
and then, when the supply voltage becomes a preset second threshold voltage lower than the first threshold voltage, the control circuit repeats: performing a short-brake operation on the motor by controlling the driver circuit, and performing an off-brake operation on the motor by controlling the driver circuit in response to the overcurrent detection signal until the supply voltage becomes the second threshold voltage,
and then, when the supply voltage becomes less than the second threshold voltage, the control circuit controls the driver circuit to continue an off-brake operation of the motor.

16. The motor drive system according to claim 13, wherein the control circuit continues an off-brake operation of the motor until the supply voltage becomes less than the first threshold voltage due to a decrease in the rotation speed of the motor, and then controls the driver circuit to continue a short-brake operation of the motor,
and then, when the supply voltage becomes a preset second threshold voltage lower than the first threshold voltage, the control circuit repeats: performing a short-brake operation on the motor by controlling the driver circuit, and performing an off-brake operation on the motor by controlling the driver circuit in response to the overcurrent detection signal until the supply voltage becomes the preset third threshold voltage lower than the first threshold voltage and higher than the second threshold voltage,
and then, when the supply voltage becomes less than the second threshold voltage, the control circuit controls the driver circuit to continue an off-brake operation of the motor.

17. The motor drive system according to claim 10, wherein the voltage detection circuit comprises:
an overvoltage detection circuit that detects whether the supply voltage is higher than a preset first threshold voltage, and outputs a signal according to a detection result as the voltage detection signal to the control circuit; and
a low voltage detection circuit that detects whether the supply voltage is lower than a preset second threshold voltage that is lower than the first threshold voltage, and outputs a signal according to a detection result as the voltage detection signal to the control circuit.

18. The motor drive system according to claim 17, wherein the voltage detection circuit detects whether the supply voltage is higher than a preset third threshold voltage that is lower than the first threshold voltage and higher than the second threshold voltage, and outputs a signal according to a detection result to the control circuit as the voltage detection signal.

19. A motor drive method that a drive of a motor is controlled by a motor drive circuit that uses power input from a power source through a power supply terminal to which one end of a smoothing capacitor is connected,
wherein the motor drive circuit comprises: a power source cutoff detection circuit that detects a voltage input through a power source cutoff detection terminal electrically connected to a power source terminal, detects that the power source has been cut off based on a detection result, and outputs a power source cutoff detection signal;
a voltage detection circuit that detects the supply voltage of the power supply terminal, and outputs a voltage detection signal based on a detection result;
a driver circuit that includes a first half bridge, a second half bridge, and a third half bridge connected in parallel between the power supply terminal and a ground terminal, the motor driver circuit supplying a drive current to the motor to rotate the motor, while the driver circuit controlling a coil current flowing through a coil of the motor to brake the motor;
an overcurrent detection circuit that detects the coil current flowing through the coil of the motor through the driver circuit during a short-brake operation of the motor, detects that the coil current is equal to or greater than a preset threshold current, and outputs an overcurrent detection signal; and
a control circuit that controls the operation of the motor by controlling the driver circuit based on the power source cutoff detection signal, the overcurrent detection signal, and the voltage detection signal.

20. The motor drive method according to claim 19, wherein the control circuit, in a state in which the motor is rotating by driving the motor normally, controls the driver circuit in response to the power source cutoff detection signal to perform a short-brake operation on the motor,
and then, during the short-brake operation, the control circuit controls all MOS transistors of the first to third half bridges of the driver circuit to be turned off in response to the overcurrent detection signal to perform an off-brake operation on the motor,
and then, when the voltage detection signal indicates that the voltage is less than a first threshold voltage, the control circuit repeats: performing a short-brake operation on the motor by controlling the driver circuit, and performing an off-brake operation on the motor by controlling the driver circuit, in response to the overcurrent detection signal, when the short-brake operation is performed.
